(19) United States
(12) Patent Application Publication
(10) Pub. No.: US 2025/0077878 A1
(43) Pub. Date: Mar. 6, 2025

(54) TRANSFORMER-BASED ADVERSARIAL ACTIVE LEARNING SYSTEM

(71) Applicant: Salesforce, Inc., San Francisco, CA (US)

(72) Inventors: Xiaolin PANG, San Francisco, CA (US); Kexin XIE, San Francisco, CA (US); Max FLEMING, San Francisco, CA (US); Chen XU, San Francisco, CA (US); Yuxi ZHANG, San Francisco, CA (US)

(73) Assignee: Salesforce, Inc., San Francisco, CA (US)

(21) Appl. No.: 18/457,262

(22) Filed: Aug. 28, 2023

(51) Int. Cl. G06N 3/091; G06N 3/0895; G06N 3/094

(52) U.S. Cl. CPC G06N 3/091; G06N 3/0895; G06N 3/094

(57) ABSTRACT

System and method for transformer-based adversarial active learning system. A machine learning system includes a generator, a transformer encoder, a classifier, and a discriminator all working in combination to generate and select unlabeled data points for labeling. The system utilizes a generative adversarial network paired with an active learning framework to optimize text embedding and feature encoding according to distribution of training data.

### FIELD OF TECHNOLOGY

This patent document relates generally to computer systems, and more specifically to machine learning.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks.

In the context of enterprise software, machine learning can boost business value due to its ability to create automation of intelligent solution through AI algorithms. The success of the AI based solutions depends on many factors. One of the key factors is that the AI model optimizes intended goals. To ensure that happens, data quality, especially the quality of a labeled dataset used for training the AI model plays a most critical role. Constructing a correct labeled dataset requires domain specific input and often varies between clients (depending on their industry, business focus, organizational strategy, and team structure). However, currently, dataset labelling is a manual process, which is not feasible for large datasets due to its intrusive and label intensive manner. Thus, there is a need for a unique approach that allows learning in a non-intrusive and non-label intensive way to generate a large amount of labeled datasets.

### BRIEF DESCRIPTION OF THE DRAWINGS

The included drawings are for illustrative purposes and serve only to provide examples of possible structures and operations for the disclosed inventive systems, apparatus, methods and computer program products for managing decentralized high risk actions across different coordinated systems. These drawings in no way limit any changes in form and detail that may be made by one skilled in the art without departing from the spirit and scope of the disclosed implementations.

FIG. 1 is a block diagram showing an example architecture for an active learning framework, in accordance with one or more embodiments.

FIG. 2A is a diagram showing generated classes without conditional entropy regularization, in accordance with one or more embodiments.

FIG. 2B is a diagram showing generated classes with conditional entropy regularization, in accordance with one or more embodiments.

FIG. 3 illustrates an example of a method for training a machine learning model, in accordance with one or more embodiments.

FIG. 4 shows a block diagram of an example of a database environment, configured in accordance with one or more embodiments.

FIG. 5A shows a system diagram of an example of architectural components of an on-demand database service environment, in accordance with embodiments.

FIG. 5B shows a system diagram further illustrating an example of architectural components of an on-demand database service environment, in accordance with one or more embodiments.

FIG. 6 illustrates one example of a computing device, configured in accordance with one or more embodiments.

### DETAILED DESCRIPTION

In the following description, numerous specific details are set forth in order to provide a thorough understanding of the present disclosure. The present disclosure may be practiced without some or all of these specific details. In other instances, well known process operations have not been described in detail to not unnecessarily obscure the present disclosure. While the disclosure will be described in conjunction with the specific embodiments, it will be understood that it is not intended to limit the disclosure to the embodiments.

As mentioned above, in order to properly train AI models, such as machine learning models, the quantity and quality of training data is very important. In order to properly train AI models, a vast amount of data is necessary. However, the quality of the data is no less important. Because the role of the AI model varies depending on its purpose, the data used to train the AI model also varies. Supervised learning involves labeling of data by a specialist and can be used to tailor an AI model for a specific use. However, because of the sheer quantity of data, current technology makes it practically infeasible for different users to develop user-tailored AI models that are not already pre-trained on predetermined training data. One possible solution is to use a semi-supervised learning model.

The techniques and mechanisms of the present disclosure provide a system and method capable of selecting representative data points for an expert domain to label the data set. Because the AI model needs to be user-specific, a domain expert is needed to label domain specific data for model training. However, current technology does not allow for generating and selecting of such data. Instead, current technology uses a large quantity of open data sets that a domain expert must manually sift through for labeling, which is why training of AI models is inefficient. For a domain expert to label data points efficiently, the correct data needs to be generated and selected for labeling. The techniques and mechanisms of the present disclosure utilizes active learning to help select high representative data points to be labeled. According to various embodiments, high representative data points are data points with high diversity and high uncertainty. By creating and selecting data points with high diversity and high uncertainty, the techniques and mechanisms of the present disclosure improve AI systems specifically by shortening AI model training time, thereby making AI systems operate more efficiently.

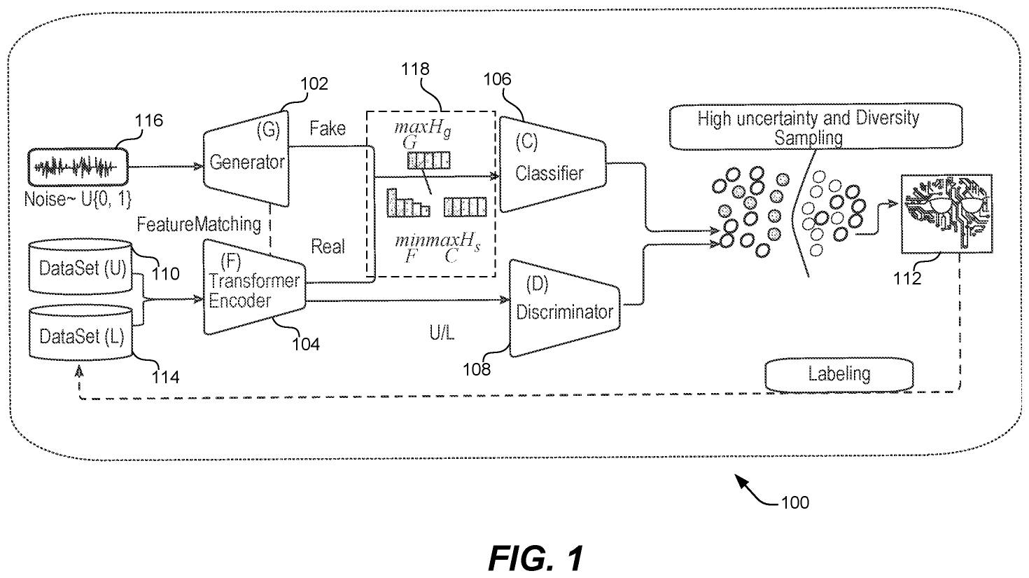

FIG. 1 is a block diagram showing an example architecture for an active learning framework, in accordance with one or more embodiments. Architecture 100 is a transformer-based adversarial semi-supervised active learning framework and includes four main components: a generator 102, a transformer encoder 104, a classifier 106, and a discriminator 108.

Because architecture 100 utilizes a semi-supervised structure, in the beginning, all data sets are unlabeled datasets 110. Eventually, the system will select data points with high uncertainty and high diversity to give to domain expert 112 to label, thereby generating labeled data sets 114. As used herein, “high uncertainty” refers to data points with a more uniform entropy distribution. As used herein, “high diversity” refers to data points with high similarity scores to “true labeled data.” In some embodiments, for each iteration, the system fills data points, selects a few data points to give to domain expert 112 to label, and increases labeled data sets 114 once the data returns as a labeled data set. In some embodiments, labeled data set 114 has a subject line and also has a label. In some embodiments, the label is a target that needs to be eventually predicted by the model. In some embodiments, unlabeled dataset 110 only has a subject line. Thus, in some embodiments, the system only feeds the subject line of unlabeled data sets 110 to transformer encoder 104 to encode to a numeric vector, e.g., [0.023, 0.345, 0.605]. For example, if a subject line of an unlabeled data set 110 includes “I have a book,” this subject line will be fed into transformer encoder 104, which will transform the subject line, which is text, into a numeric vector that represents the text. In the example, the line of text, “I have a book,” is a data point. In some embodiments, a data point can be a person, animal, an object, or any type of “thing.” In some embodiments, each data point has multiple different features. Each feature can be represented as a numerical value, e.g., 0.023. Back to the example, the data point “I have a book” can be split into multiple “tokens,” with each individual word being a token, e.g., “I” or “book.” In some embodiments, each token has many different features that can be represented as a numerical value. For example, one feature of a token is the frequency of the token used in a document. Thus, in the same example, the token “I” may appear three times, the token “have” may appear one time, the token “a” may appear ten times, and the token “book” may appear four times. Therefore, in the example, a numeric vector corresponding to frequency of the tokens in a document for the data point “I have a book,” can be represented as [3, 1, 10, 4].

In some embodiments, transformer encoder 104 is used as the feature encoder. In some embodiments, the encoded features are fine-tuned through the logit activation layer of classifier 106 and discriminator 108. In some embodiments, transformer encoder is also configured to, for labeled data, maximize the probability of class assignment from classifier 106 by performing entropy minimization. This is because when the model is training, multi-class features (with a binary probability determination) are used for helping class assignments. In other embodiments, discriminator 108 is configured to include an entropy regulizer in order to perform entropy minimization on the output of transformer encoder 104. In some embodiments, transformer encoder 104 is also trained to differentiate labeled and unlabeled data output from discriminator 108. In some embodiments, for unlabeled data, transformer encoder 104 is trained to minimize the entropy to have better discriminative features.

In some embodiments, discriminator 108 is a binary classifier. Because the input to discriminator 108 is either labeled data or unlabeled data, there is a high amount of certainty within a binary classification. In some embodiments, discriminator 108 is used to predict whether a sample is labeled or not based on a latent representation from transformer encoder 104. In some embodiments, unlabeled data points with low discriminator scores are selected for labeling because the low scores indicate that these samples are sufficiently different from previously labeled ones.

According to various embodiments, system 100 includes generator 102. In some embodiments, generator 102 acts in an adversarial manner to fool classifier 106 by generating highly realistic data samples. In some embodiments, generator 102 takes noise input 116 (e.g., a uniform noise distribution) and transforms the noise into a true data distribution. In some embodiments, the transformed noise input is treated as a k+1th addition class for semi-supervised learning. In some embodiments, to enhance the robustness and reduce mode collapse, generator 102 is trained to apply feature matching between generated samples and real data. Moreover, in some embodiments, conditional entropy maximization over samples from generator 102 is employed as well. In other words, generator 102 is configured to use noise 116 as input to generate fake data points to fool classifier 106, in order to strengthen the classifier to differentiate between fake and real data points. The techniques and mechanisms of the present disclosure combine this adversarial learning with active learning to strengthen and improve the classification abilities of current technology. The active learning part addresses how to select the data points needed for classification. In some embodiments, labeling is multi-class, meaning the system must differentiate between multiple classes, as well as fake vs real.

According to various embodiments, the output of generator 102 is given to classifier 106 to differentiate data points for selection. In some embodiments, classifier 106 is designed to pair with generator 102 and can be treated as a multi-class discriminator for k+1 classes. For example, for labeled data, it is trained to differentiate k classes, as well as a k+1th fake class. In some embodiments, classifier 106 is also configured to, for unlabeled data, optimize minimax loss by performing entropy maximization with respect to a predicted class and entropy minimization with respect to a fine-tuned feature encoder. Entropy maximization makes the prediction follow a more uniform class distribution. The understanding here is that because the true label of an unlabeled sample is unknown, the model should not optimize the classifier to only maximize the predicted labels. This gives “high uncertainty” to the data distribution. Entropy minimization encourages unlabeled samples associated with similar predicted labels to have similar features. This helps to extract discriminative features when training the model. This gives “high diversity” to the data distribution because the model is trained to select points that are most similar to the true labeled data. In some embodiments, transformer encoder 104 is configured to include an entropy regulizer in order to perform entropy minimization.

In some embodiments, classifier 106 reduces the distribution gap, while extracting discriminative features from data points. In some embodiments, classifier 106 selects samples having high entropy to be labeled, which indicates these samples are predicted by the model with high uncertainty. In some embodiments, classifier 106 also includes a regulator to penalize for selecting fake data points. In such embodiments, penalizing is part of the active learning process.

In some embodiments, classifier 106 is configured to generate max entropy, or perform entropy maximization on the data points, in order to address the problem of mode collapse. In other embodiments, generator 102 is configured to include an entropy regulizer to perform entropy maximation on the output of generator 102. Mode collapse occurs when a generative adversarial network learns some iterations that it can discriminate well and then gets stuck between one or two modes. This can be a problem because then the adversarial network only generates fake data points that are limited to a specific subset of fake data points, which prevents the adversarial network from being robust. Thus, system 100 is configured to maximize entropy in order to generate more uniform data points to cover more classes. In some embodiments, a separate entropy module performs the entropy maximization. One example algorithm for maximizing entropy is presented as algorithm 1 below.

Algorithm 1: Adversarial Semi-Supervised Active Learning (t-ASAL)

Input: Labeled data S^{l}, unlabeled data S^{u}
Initialize the parameters of the Generator G_{ϕ}, discriminator D_{γ} and classifier
C_{θ}. Get transformer encoder parameters F_{β} for fine-tuning.
while i ≤ epochs do
| Sample batch of size n from S^{l} labelled and S^{u} unlabeled data
$\vert \vert {S}^{l} \vert = \vert {S}^{u} \vert = n$
| Generate encode F(S^{l}) and F(S^{u})
| Sample {z₁, . . . , zₙ} from the prior P,
| For labelled data (x, y ∈ S^{l}): update C_{θ} by descending:
$\vert \frac{1}{n} {\sum }_{j = 1}^{n} log ( p ( y \leq k \vert x ) )$
| and update G_{γ} by minimizing:
$\vert {min}_{∀ {x}_{i} ∈ {S}^{l}} {‖ f ( {G}_{ϕ} ( {z}_{i} ) - f ( {x}_{j} ) ) ‖}_{2}^{2} + {min}_{x \sim {p}_{θ}} ( - {\sum }_{j = 1}^{n} log [ 1 - p ( y \leq k \vert x ) ] - {\sum }_{j = 1}^{n} p ( y \leq k \vert x ) log [ p ( y \leq k \vert x ) ] )$
| For unlabelled data S^{u}, update C_{θ} and F_{β} by minmaxing entropy:
$\vert \frac{1}{n} {\sum }_{j = 1}^{n} p ( y \leq k \vert x ) log p ( y \leq k \vert x )$
| and update G_{ϕ} by minimizing:
$\vert {min}_{∀ {x}_{i} ∈ {S}^{u}} {‖ f ( {G}_{θ} ( {z}_{i} ) - f ( {x}_{i} ) ) ‖}_{2}^{2}$
| For labelled data and unlabeled data (x, y) ∈ S^{l} ∪ S^{u}, update D_{γ} by descending:
$\vert - \frac{1}{n} {\sum }_{j = 1}^{n} log [ p ( {y}^{l} \vert {x}^{l} ) ] - \frac{1}{n} {\sum }_{j = 1}^{n} log [ p ( {y}^{u} \vert {x}^{u} ) ]$

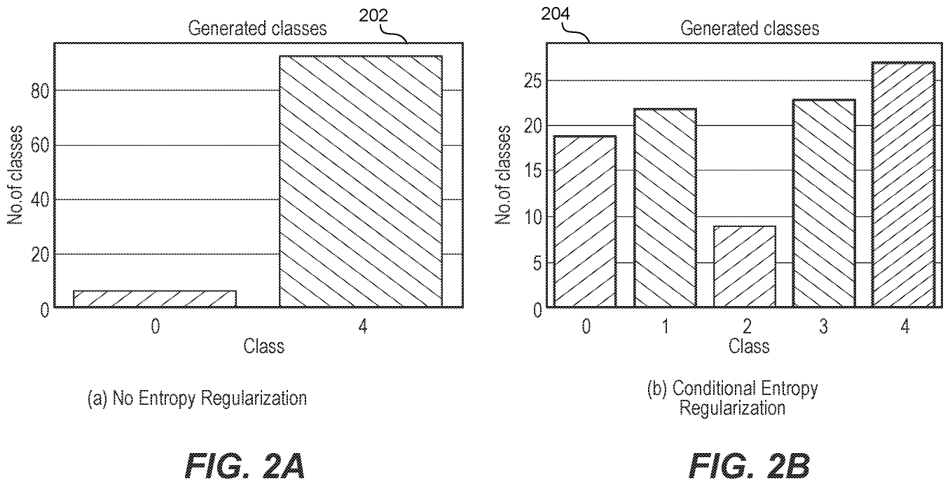

FIG. 2A is a diagram showing generated classes without conditional entropy regularization, in accordance with one or more embodiments. Without entropy regularization, the generative adversarial network would only generate data points that belong to one of two classes, e.g., class 0 or 4, as shown in graph 202. FIG. 2B is a diagram showing generated classes with conditional entropy regularization, in accordance with one or more embodiments. As shown in graph 204, with an entropy regulizer, data points can be generated for many classes. The techniques and mechanisms of the present disclosure utilize entropy regulation in conjunction with active learning in order to effectively differentiate the distributions of labeled and unlabeled data in a more refined manner and facilitates auto-selection of most important (data points with high uncertainty and diversity) data points for expert labeling. The introduction of entropy regulization does not help a machine learning model to learn faster, but rather more accurately. In other words, the addition of entropy regulization into the adversarial active learning model allows the system to more sensitive to differences in data and allows for selection of higher quality representative samples to be labeled. Current technology does not have the ability to do this.

As mentioned above, in some embodiments, minimax entropy optimization for unlabeled data is employed to reduce the distribution gap with labeled data while extracting discriminative features for selecting highly representative data samples. This, along with conditional entropy maximization in the adversarial network, can be performed in a separate module in between classifier 106 and the output of generator 102 and transformer enhancer 104, in order to enhance the robustness architecture 100 and generate uniform-distributed samples. In other words, in some embodiments, the outputs of transformer encoder 104 and generator 102 go into entropy analyzer box 118. Entropy analyzer 118 then gives a maximum entropy for the output of generator 102. In some embodiments, the max entropy is part of generator 102, and the minimax is part of transformer encoder 104. With maximum entropy, generator 102 will generate more real data points, which can help to generate synthetic data to simulate real data points for future model training.

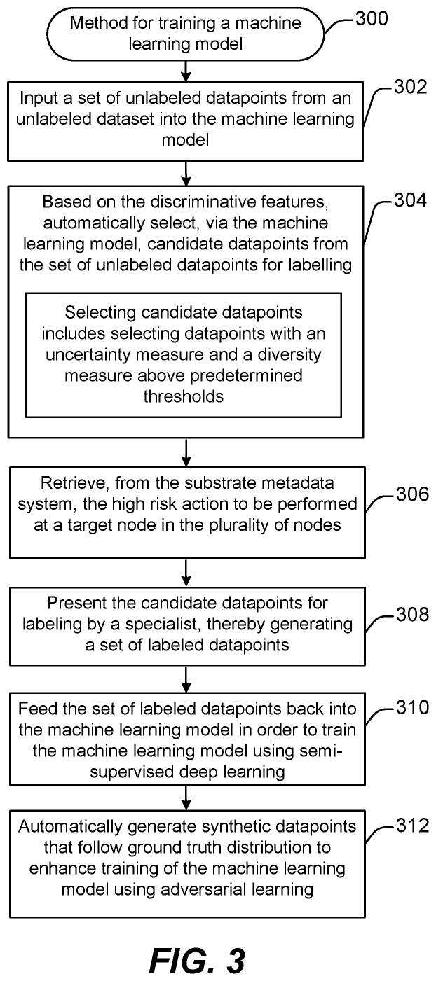

FIG. 3 illustrates an example of a method for training a machine learning model, in accordance with one or more embodiments. Method 300 begins with inputting (302) a set of unlabeled datapoints from an unlabeled dataset into the machine learning model. At 304, based on the discriminative features, method 300 includes automatically selecting, via the machine learning model, candidate datapoints from the set of unlabeled datapoints for labelling. In some embodiments, selecting candidate datapoints includes selecting datapoints with an uncertainty measure and a diversity measure above predetermined thresholds. At 306, method 300 includes retrieving, from the substrate metadata system, the high risk action to be performed at a target node in the plurality of nodes. At 308, method 300 includes presenting the candidate datapoints for labeling by a specialist, thereby generating a set of labeled datapoints. At 310, method 300 includes feeding the set of labeled datapoints back into the machine learning model in order to train the machine learning model using semi-supervised deep learning. Finally, at 312, method 300 includes automatically generating synthetic datapoints that follow ground truth distribution to enhance training of the machine learning model using adversarial learning.

According to various embodiments, the techniques and mechanisms of the present disclosure provide the ability to execute high-risk actions using de-centralized and isolated components. In some embodiments, the components include a monitoring system that acts as a high-risk activity advisor, a two-way messaging component, and a plurality of disparate coordinated computer systems. In some embodiments, the isolated components operate independently and without domain-specific authentication and authorization controls. In some embodiments, the two-way messaging component allows the advisor to send actions to the coordinated systems and for those systems to push updates about their status back to the advisor so they can be tracked. In some embodiments, the various coordinated systems, in a de-centralized fashion, are able to independently perform the high-risk actions themselves, in a safe manner (such that end-user access and data integrity and availability are maintained), without direct supervision from the advisor. In some embodiments, the de-centralized nature of the solution means the coordinator/advisor does not need any access to the systems it operates on, providing stronger security and less configuration burden. In some embodiments, the de-centralized nature of the solution means the coordinator/advisor does not have to have any special technology, or vendor-specific knowledge of the coordinated systems it operates on. In some embodiments, the monitoring/advisor system uses health signals from the target coordinated system to determine if the desired actions can be taken and when to take them. In some embodiments, the monitoring/advisor system, based on hints provided by the configuration management system, is automatically aware of the failure domains (for example, geographically-isolated data centers) of the coordinated system and is able to operate in such a way to avoid executing the action on more than one failure domain at a time. In some embodiments, to reduce disruption in the overall coordinated system, the de-centralized nature of the solution allows for a hand-off where the target of the coordinated system can make decisions specific to its role, health, and variable state when the action is requested and has the ability to defer the action for later. In some embodiments, the coordinated system, having an internal view more nuanced than that of the monitoring/advisor system, is able to temporarily decline requests to perform the requested action to reduce impact to connected clients. In some embodiments, the actions performed on the coordinated system are re-entrant and idempotent, i.e., the process on many hundreds of nodes may take place over several days and is thus subject to a variety of failure modes. However, in such embodiments the process can be restarted at any time and is guaranteed to pick up where it left off. In addition, in such embodiments, if the action has already been executed but, in error, is requested again it will not be executed twice. In some embodiments, the process automatically interrupts itself on pre-configured time boundaries so that the stream of actions is automatically paused, e.g., until at the end of business to avoid after-hours interruptions, or is configured to only run on weekends when interruptions are less disruptive to business. In some embodiments, the techniques and mechanisms of the present disclosure do not require a need to fence or lock multiple conflicting processes on the stream of actions from running concurrently, since they natively cannot conflict. In current technology and prior art, two executions of an action could lead to disastrous consequences.

The techniques and mechanisms of the present disclosure provide several advantages over current technology and prior art. Existing solutions are opinionated and specific to particular products or technologies. For example, Oracle Enterprise Manager, provides a degree of actions on its coordinated system (the Oracle Database) but has no capabilities or functions outside this vendor-specific space. Existing systems also require specific network connections and authentication to the target systems whereas ours is entirely de-centralized and relies instead on native cloud identities and connections.

According to various embodiments, the de-centralized nature of the solution presented herein means the coordinator does not need any access to the systems it operates on, since monitoring data is available, thus providing stronger security and less configuration burden. Existing solutions require usernames, passwords, certificates, and network ports between the components to be open, increasing operational overhead and opening new attack surfaces. In some embodiments, improved security is provided in the solution provided herein by requiring access only to the existing cloud substrate, not from any centralized (thus desirable attack vector) access point.

Using only current technology, in an enterprise with multiple types of coordinated systems (for example both the Oracle Database and MongoDB), multiple vendor-specific solutions would be necessary to coordinate actions, thereby increasing costs and operational burden, training staff on each, and acquiring, implementing, configuring, and monitoring each solution individually. The techniques and mechanisms of the present disclosure provide for a one-size-fits-all solution.

The techniques and mechanisms of the present disclosure are not obvious because they are based on designing and planning around the concepts of: de-centralization and avoidance of tight coupling, thus pushing the opinionated parts out to the edge inside the coordinated systems. The techniques and mechanisms of the present disclosure also provide improved security through a lightly-authenticated and loosely-coupled two-way messaging layer. In addition, the techniques and mechanisms of the present disclosure provide improved health awareness by use of the monitoring system with a high degree of safety. In addition, the techniques and mechanisms of the present disclosure provide for extreme automation and predictability provided by the configuration management system.

According to various embodiments, the monitoring system uses health signals from the target coordinated system to determine if the desired actions can be taken and when to take them. This is unique in that existing systems are assumed to have a good idea of the health of their own context (in the Oracle Enterprise Manager example: the state of the Oracle Database itself), but have no data on other aspects of the system as a whole, e.g., the capacity of a filesystem on a remote node not managed by Oracle or not germane to its database but nonetheless significant. Existing solutions in this space do not have access to monitoring system health signals.

In some embodiments, the monitoring system, in addition to coordinated system health signals, incorporates operator-defined exceptions to health issues such that actions can be executed despite them. This allows a point-in-time flexibility over executing actions despite errant health signals once they are acknowledged as acceptable.

In some embodiments, in hard-failure cases the operation is stopped without interruption to clients of the coordinated system. In some embodiments, in soft-failure cases, the operation is paused to allow the coordinated system to self-heal, but such a state will eventually promote to a hard-failure case, if the coordinated system does not self-heal, to stop the operation. This is unique because existing systems cannot automatically detect and handle unforeseen signals on the whole of the coordinated system, nor are they equipped to wait for these signals to self-heal before proceeding with the actions on the next target.

According to various embodiments, the techniques and mechanisms of the present disclosure provides a framework to deliver actions to an arbitrary list of coordinated (and simpler uncoordinated) computer systems. In such embodiments, the components delivered to and executed as part of the solution within the coordinated computer system are pluggable as part of a generic framework and easily tuned to the use case of each specific coordinated system and its needs. In some embodiments, the configuration management system provides the coordinated system with the data it needs to coordinate nodes of the system, such as knowing what nodes comprise a database system. In some embodiments, the configuration management system provides the monitoring system with the population of nodes that comprise each coordinated computer system and what signals to pull from those nodes to ascertain the health of those systems as a distinct entity. In some embodiments, native authentication to the substrate is configured by the configuration management system and allows two-way communication between the monitoring system and the coordinated system. In some embodiments, the monitoring system requests the actions against each coordinated computer system in a consistent order each time the actions are executed such that the order of operations and their impact is more predictable.

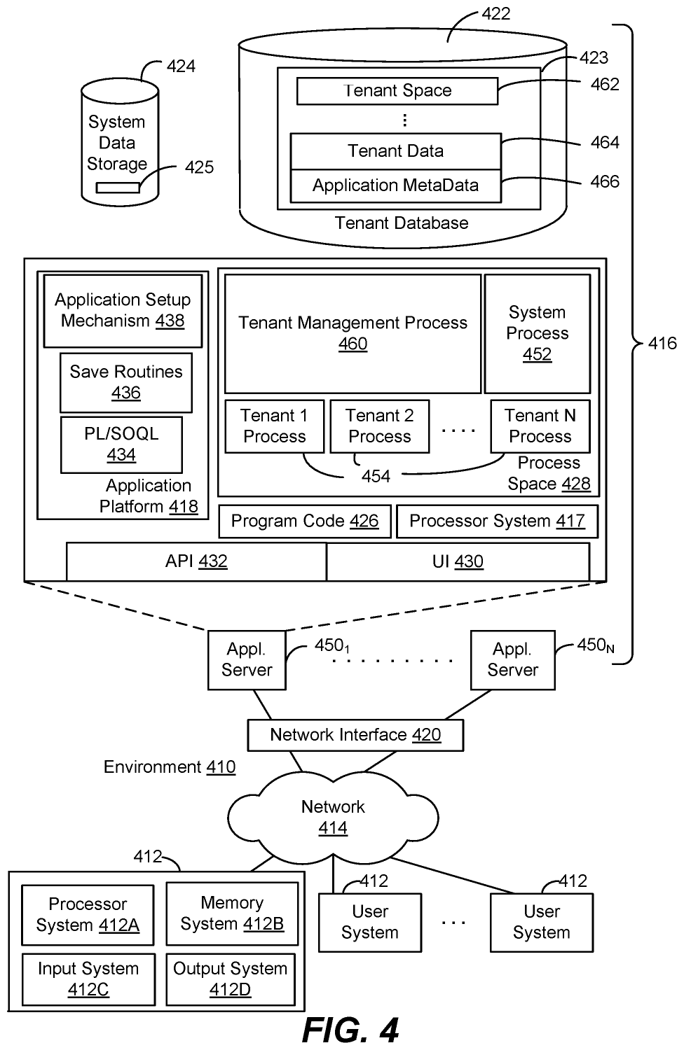

FIG. 4 shows a block diagram of an example of an environment 410 that includes an on-demand database service configured in accordance with some implementations. Environment 410 may include user systems 412, network 414, database system 416, processor system 417, application platform 418, network interface 420, tenant data storage 422, tenant data 423, system data storage 424, system data 425, program code 426, process space 428, User Interface (UI) 430, Application Program Interface (API) 432, PL/SOQL 434, save routines 436, application setup mechanism 438, application servers 450-1 through 450-N, system process space 452, tenant process spaces 454, tenant management process space 460, tenant storage space 462, user storage 464, and application metadata 466. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 416, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 418 may be a framework that allows the creation, management, and execution of applications in system 416. Such applications may be developed by the database service provider or by users or third-party application developers accessing the service. Application platform 418 includes an application setup mechanism 438 that supports application developers' creation and management of applications, which may be saved as metadata into tenant data storage 422 by save routines 436 for execution by subscribers as one or more tenant process spaces 454 managed by tenant management process 460 for example. Invocations to such applications may be coded using PL/SOQL 434 that provides a programming language style interface extension to API 432. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 466 for a subscriber making such an invocation. Such system processes may also manage execution of application metadata 466 as an application in a virtual machine.

In some implementations, each application server 450 may handle requests for any user associated with any organization. A load balancing function (e.g., an F5 Big-IP load balancer) may distribute requests to the application servers 450 based on an algorithm such as least-connections, round robin, observed response time, etc. Each application server 450 may be configured to communicate with tenant data storage 422 and the tenant data 423 therein, and system data storage 424 and the system data 425 therein to serve requests of user systems 412. The tenant data 423 may be divided into individual tenant storage spaces 462, which can be either a physical arrangement and/or a logical arrangement of data. Within each tenant storage space 462, user storage 464 and application metadata 466 may be similarly allocated for each user. For example, a copy of a user's most recently used (MRU) items might be stored to user storage 464. Similarly, a copy of MRU items for an entire tenant organization may be stored to tenant storage space 462. A UI 430 provides a user interface and an API 432 provides an application programming interface to system 416 resident processes to users and/or developers at user systems 412.

System 416 may implement a web-based processing engine system. For example, in some implementations, system 416 may include application servers configured to implement and execute processing engine software applications. The application servers may be configured to provide related data, code, forms, web pages and other information to and from user systems 412. Additionally, the application servers may be configured to store information to, and retrieve information from, a database system. Such information may include related data, objects, and/or Webpage content. With a multi-tenant system, data for multiple tenants may be stored in the same physical database object in tenant data storage 422, however, tenant data may be arranged in the storage medium(s) of tenant data storage 422 so that data of one tenant is kept logically separate from that of other tenants. In such a scheme, one tenant may not access another tenant's data, unless such data is expressly shared.

Several elements in the system shown in FIG. 4 include conventional, well-known elements that are explained only briefly here. For example, user system 412 may include processor system 412A, memory system 412B, input system 412C, and output system 412D. A user system 412 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 412 to access, process and view information, pages and applications available from system 416 over network 414. Network 414 may be any network or combination of networks of devices that communicate with one another, such as any one or any combination of a LAN (local area network), WAN (wide area network), wireless network, or other appropriate configuration.

The users of user systems 412 may differ in their respective capacities, and the capacity of a particular user system 412 to access information may be determined at least in part by “permissions” of the particular user system 412. As discussed herein, permissions generally govern access to computing resources such as data objects, components, and other entities of a computing system, such as a processing engine, a social networking system, and/or a CRM database system. “Permission sets” generally refer to groups of permissions that may be assigned to users of such a computing environment. For instance, the assignments of users and permission sets may be stored in one or more databases of System 416. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 416 may provide on-demand database service to user systems 412 using an MTS arrangement. By way of example, one tenant organization may be a company that employs a sales force where each salesperson uses system 416 to manage their sales process. Thus, a user in such an organization may maintain contact data, leads data, customer follow-up data, performance data, goals and progress data, etc., all applicable to that user's personal sales process (e.g., in tenant data storage 422). In this arrangement, a user may manage his or her sales efforts and cycles from a variety of devices, since relevant data and applications to interact with (e.g., access, view, modify, report, transmit, calculate, etc.) such data may be maintained and accessed by any user system 412 having network access.

When implemented in an MTS arrangement, system 416 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 416 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 416 may also maintain system-level data usable by multiple tenants or other data. Such system-level data may include industry reports, news, postings, and the like that are sharable between tenant organizations.

In some implementations, user systems 412 may be client systems communicating with application servers 450 to request and update system-level and tenant-level data from system 416. By way of example, user systems 412 may send one or more queries requesting data of a database maintained in tenant data storage 422 and/or system data storage 424. An application server 450 of system 416 may automatically generate one or more SQL statements (e.g., one or more SQL queries) that are designed to access the requested data. System data storage 424 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale process, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

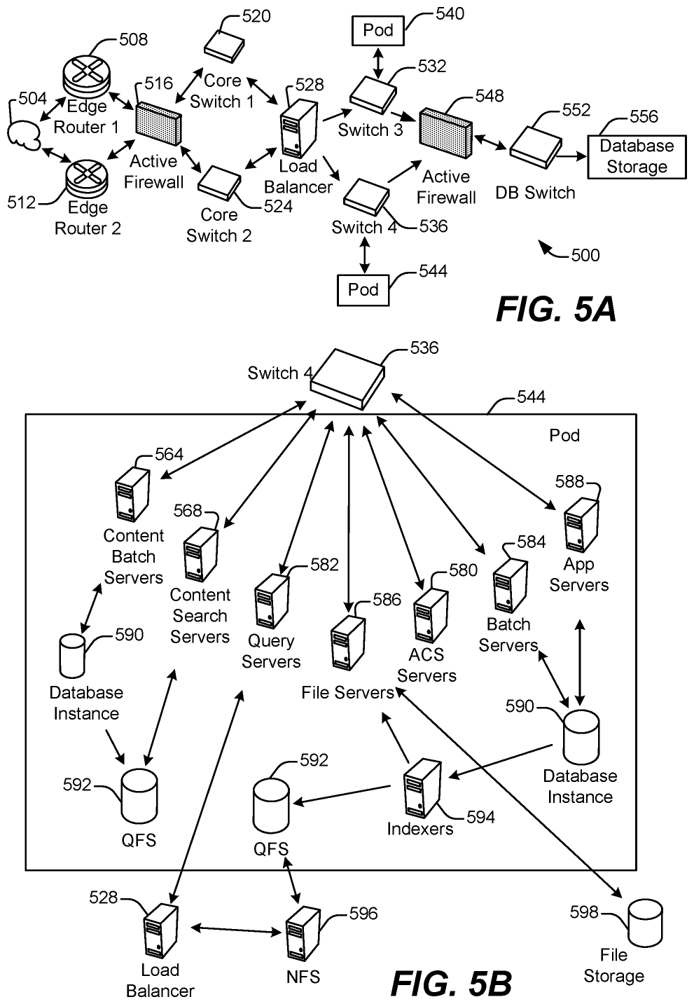

FIG. 5A shows a system diagram of an example of architectural components of an on-demand database service environment 500, configured in accordance with some implementations. A client machine located in the cloud 504 may communicate with the on-demand database service environment via one or more edge routers 508 and 512. A client machine may include any of the examples of user systems 412 described above. The edge routers 508 and 512 may communicate with one or more core switches 520 and 524 via firewall 516. The core switches may communicate with a load balancer 528, which may distribute server load over different pods, such as the pods 540 and 544 by communication via pod switches 532 and 536. The pods 540 and 544, which may each include one or more servers and/or other computing resources, may perform data processing and other operations used to provide on-demand services. Components of the environment may communicate with a database storage 556 via a database firewall 548 and a database switch 552.

Accessing an on-demand database service environment may involve communications transmitted among a variety of different components. The environment 500 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 5A and 5B.

The cloud 504 refers to any suitable data network or combination of data networks, which may include the Internet. Client machines located in the cloud 504 may communicate with the on-demand database service environment 500 to access services provided by the on-demand database service environment 500. By way of example, client machines may access the on-demand database service environment 500 to retrieve, store, edit, and/or process processing engine information.

In some implementations, the edge routers 508 and 512 route packets between the cloud 504 and other components of the on-demand database service environment 500. The edge routers 508 and 512 may employ the Border Gateway Protocol (BGP). The edge routers 508 and 512 may maintain a table of IP networks or ‘prefixes’, which designate network reachability among autonomous systems on the internet.

In one or more implementations, the firewall 516 may protect the inner components of the environment 500 from internet traffic. The firewall 516 may block, permit, or deny access to the inner components of the on-demand database service environment 500 based upon a set of rules and/or other criteria. The firewall 516 may act as one or more of a packet filter, an application gateway, a stateful filter, a proxy server, or any other type of firewall.

In some implementations, the core switches 520 and 524 may be high-capacity switches that transfer packets within the environment 500. The core switches 520 and 524 may be configured as network bridges that quickly route data between different components within the on-demand database service environment. The use of two or more core switches 520 and 524 may provide redundancy and/or reduced latency.

In some implementations, communication between the pods 540 and 544 may be conducted via the pod switches 532 and 536. The pod switches 532 and 536 may facilitate communication between the pods 540 and 544 and client machines, for example via core switches 520 and 524. Also or alternatively, the pod switches 532 and 536 may facilitate communication between the pods 540 and 544 and the database storage 556. The load balancer 528 may distribute workload between the pods, which may assist in improving the use of resources, increasing throughput, reducing response times, and/or reducing overhead. The load balancer 528 may include multilayer switches to analyze and forward traffic.

In some implementations, access to the database storage 556 may be guarded by a database firewall 548, which may act as a computer application firewall operating at the database application layer of a protocol stack. The database firewall 548 may protect the database storage 556 from application attacks such as structure query language (SQL) injection, database rootkits, and unauthorized information disclosure. The database firewall 548 may include a host using one or more forms of reverse proxy services to proxy traffic before passing it to a gateway router and/or may inspect the contents of database traffic and block certain content or database requests. The database firewall 548 may work on the SQL application level atop the TCP/IP stack, managing applications' connection to the database or SQL management interfaces as well as intercepting and enforcing packets traveling to or from a database network or application interface.

In some implementations, the database storage 556 may be an on-demand database system shared by many different organizations. The on-demand database service may employ a single-tenant approach, a multi-tenant approach, a virtualized approach, or any other type of database approach. Communication with the database storage 556 may be conducted via the database switch 552. The database storage 556 may include various software components for handling database queries. Accordingly, the database switch 552 may direct database queries transmitted by other components of the environment (e.g., the pods 540 and 544) to the correct components within the database storage 556.

FIG. 5B shows a system diagram further illustrating an example of architectural components of an on-demand database service environment, in accordance with some implementations. The pod 544 may be used to render services to user(s) of the on-demand database service environment 500. The pod 544 may include one or more content batch servers 564, content search servers 568, query servers 582, file servers 586, access control system (ACS) servers 580, batch servers 584, and app servers 588. Also, the pod 544 may include database instances 590, quick file systems (QFS) 592, and indexers 594. Some or all communication between the servers in the pod 544 may be transmitted via the switch 536.

In some implementations, the app servers 588 may include a framework dedicated to the execution of procedures (e.g., programs, routines, scripts) for supporting the construction of applications provided by the on-demand database service environment 500 via the pod 544. One or more instances of the app server 588 may be configured to execute all or a portion of the operations of the services described herein.

In some implementations, as discussed above, the pod 544 may include one or more database instances 590. A database instance 590 may be configured as an MTS in which different organizations share access to the same database, using the techniques described above. Database information may be transmitted to the indexer 594, which may provide an index of information available in the database 590 to file servers 586. The QFS 592 or other suitable filesystem may serve as a rapid-access file system for storing and accessing information available within the pod 544. The QFS 592 may support volume management capabilities, allowing many disks to be grouped together into a file system. The QFS 592 may communicate with the database instances 590, content search servers 568 and/or indexers 594 to identify, retrieve, move, and/or update data stored in the network file systems (NFS) 596 and/or other storage systems.

In some implementations, one or more query servers 582 may communicate with the NFS 596 to retrieve and/or update information stored outside of the pod 544. The NFS 596 may allow servers located in the pod 544 to access information over a network in a manner similar to how local storage is accessed. Queries from the query servers 522 may be transmitted to the NFS 596 via the load balancer 528, which may distribute resource requests over various resources available in the on-demand database service environment 500. The NFS 596 may also communicate with the QFS 592 to update the information stored on the NFS 596 and/or to provide information to the QFS 592 for use by servers located within the pod 544.

In some implementations, the content batch servers 564 may handle requests internal to the pod 544. These requests may be long-running and/or not tied to a particular customer, such as requests related to log mining, cleanup work, and maintenance tasks. The content search servers 568 may provide query and indexer functions such as functions allowing users to search through content stored in the on-demand database service environment 500. The file servers 586 may manage requests for information stored in the file storage 598, which may store information such as documents, images, basic large objects (BLOBs), etc. The query servers 582 may be used to retrieve information from one or more file systems. For example, the query system 582 may receive requests for information from the app servers 588 and then transmit information queries to the NFS 596 located outside the pod 544. The ACS servers 580 may control access to data, hardware resources, or software resources called upon to render services provided by the pod 544. The batch servers 584 may process batch jobs, which are used to run tasks at specified times. Thus, the batch servers 584 may transmit instructions to other servers, such as the app servers 588, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

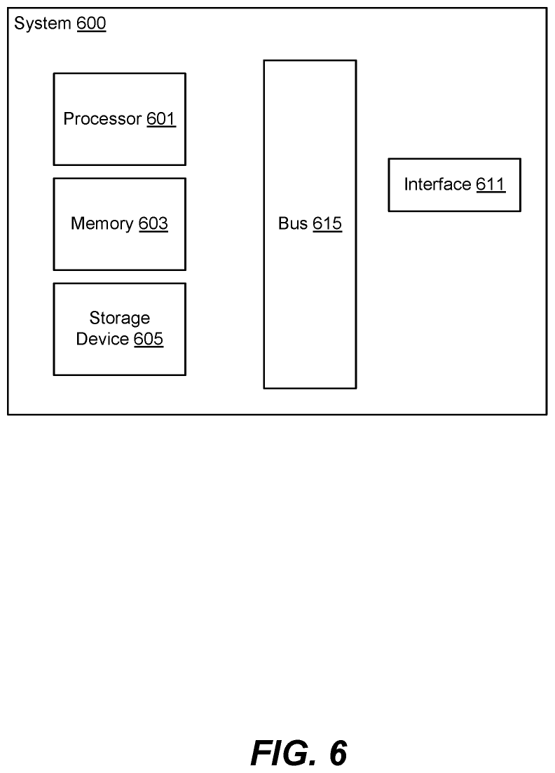

FIG. 6 illustrates one example of a computing device. According to various embodiments, a system 600 suitable for implementing embodiments described herein includes a processor 601, a memory module 603, a storage device 605, an interface 611, and a bus 615 (e.g., a PCI bus or other interconnection fabric.) System 600 may operate as variety of devices such as an application server, a database server, or any other device or service described herein. Although a particular configuration is described, a variety of alternative configurations are possible. The processor 601 may perform operations such as those described herein. Instructions for performing such operations may be embodied in the memory 603, on one or more non-transitory computer readable media, or on some other storage device. Various specially configured devices can also be used in place of or in addition to the processor 601. The interface 611 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of on-demand computing environments that include MTSs. However, the techniques of disclosed herein apply to a wide variety of computing environments. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

What is claimed is:

1. A system comprising:
a processor;
memory;
a transformer encoder configured to transform text data in unlabeled and labeled data sets into numeric vectors;
a generator configured to generate fake data points from noise for adversarial network training;
a classifier configured to function as a multi-class discriminator of data points and to select high representative data points for labeling, wherein output from the transformer encoder and generator is fed as input into the classifier; and
a discriminator configured to predict whether a data sample is labeled or not based on latent presentation from the transformer encoder.

2. The system of claim 1, wherein the generator feature matches the noise to data points in the unlabeled and labeled data sets in order to generate the fake data points.

3. The system of claim 1, wherein conditional entropy regulation is performed on the fake data points to prevent mode collapse.

4. The system of claim 1, wherein minimax entropy optimization is employed for data points in the unlabeled data sets to reduce distribution gaps with data points from the labeled data sets.

5. The system of claim 1, wherein high representative data points are defined by having high diversity and high uncertainty.

6. The system of claim 1, wherein the classifier is configured to discriminate between k classes as well as a k+1th fake class.

7. The system of claim 1, wherein each of the generator, transformer encoder, classifier, and discriminator is implemented as a neural network.

8. The system of claim 1, wherein the classifier includes an entropy regulizer for performing entropy maximization on data point distributions.

9. The system of claim 1, wherein the transformer encoder includes an entropy regulizer for performing entropy minimization on data point distributions.

10. The system of claim 1, wherein entropy regulization is performed on data point distributions to facilitate selection of data points with high uncertainty and high diversity.

11. A machine learning model comprising:
a transformer encoder configured to transform text data in unlabeled and labeled data sets into numeric vectors;
a generator configured to generate fake data points from noise for adversarial network training;
a classifier configured to function as a multi-class discriminator of data points and to select high representative data points for labeling, wherein output from the transformer encoder and generator is fed as input into the classifier; and
a discriminator configured to predict whether a data sample is labeled or not based on latent presentation from the transformer encoder.

12. The machine learning model of claim 11, wherein the generator feature matches the noise to data points in the unlabeled and labeled data sets in order to generate the fake data points.

13. The machine learning model of claim 11, wherein conditional entropy regulation is performed on the fake data points to prevent mode collapse.

14. The machine learning model of claim 11, wherein minimax entropy optimization is employed for data points in the unlabeled data sets to reduce distribution gaps with data points from the labeled data sets.

15. The machine learning model of claim 11, wherein high representative data points are defined by having high diversity and high uncertainty.

16. The machine learning model of claim 11, wherein the classifier is configured to discriminate between k classes as well as a k+1th fake class.

17. The machine learning model of claim 11, wherein each of the generator, transformer encoder, classifier, and discriminator is implemented as a neural network.

18. The machine learning model of claim 11, wherein the classifier includes an entropy regulizer for performing entropy maximization on data point distributions.

19. The machine learning model of claim 11, wherein the transformer encoder includes an entropy regulizer for performing entropy minimization on data point distributions.

20. A method comprising:
inputting a set of unlabeled datapoints from an unlabeled dataset into the machine learning model;
extracting discriminative features from high dimensional text data for multi-class classification;
based on the discriminative features, automatically selecting, via the machine learning model, candidate datapoints from the set of unlabeled datapoints for labelling, wherein selecting candidate datapoints includes selecting datapoints with an uncertainty measure and a diversity measure above predetermined thresholds;
presenting the candidate datapoints for labeling by a specialist, thereby generating a set of labeled datapoints;
feeding the set of labeled datapoints back into the machine learning model in order to train the machine learning model using semi-supervised deep learning; and
automatically generating synthetic datapoints that follow ground truth distribution to enhance training of the machine learning model using adversarial learning.
